(19) United States
(12) Patent Application Publication
(10) Pub. No.: US 2004/0209499 A1
(43) Pub. Date: Oct. 21, 2004

(54) Foldable power supply plug

(76) Inventor: Yu-Lin Chung, Taipei (TW)

Correspondence Address: BACON & THOMAS, PLLC, 625 SLATERS LANE, FOURTH FLOOR, ALEXANDRIA, VA, 22314

(21) Appl. No.: 10/413,311

(22) Filed: Apr. 15, 2003

(51) Int. Cl. H01R 13/44

(52) U.S. Cl. 439/131

(57) ABSTRACT

A foldable power supply plug device. The device includes a plug, a spring, a case, and a button switch in a housing. The spring hooks to an end of the plug while the case encloses the plug. When unused, the plug is folded inside the lower cover. Upon pressing of the button switch, the plug is actuated to conduct electricity.

### BACKGROUND OF THE INVENTION

1) Field of the Invention

The present invention relates to a foldable power supply plug, more particularly a plug for power supply which, for users' convenience, can be actuated upon pressing a button switch.

2) Description of the Prior Art

The conventional power supply plug for a mobile phone, PDA (personal digital assistant), notebook or digital camera, as shown FIG. 1, comprises a main body (100) with a power supply plug (200) on one end to connect with an ordinary outlet and a power output cord (300) on the other to link up with a jack connector (400). Said jack connector (400) can be connected with a power socket of mobile phones, notebooks or digital cameras to energize or recharge the electronic applications.

However, the power supply plug (200) of the conventional power supply tends to be riveted and unfoldable. Said power supply plug (200) is exposed extensively and thus increases the risk of bending or even break when hitten by extrinsic forces.

### SUMMARY OF THE INVENTION

The main purpose of the present invention is to dispose a button switch on a power supply plug. When said button switch is pressed, the resilience of the spring flips and releases the plug. When the plug is not in use, the plug is folded and concealed inside the housing. Therefore, it would not be bent or broken by extrinsic forces.

To enable a further understanding of the structure and functions of the invention herein, the brief description of the drawings below are followed by detailed description of the most preferred embodiment of the present invention.

### BRIEF DESCRIPTION OF THE DRAWINGS

FIG. 1 is a perspective drawing of a conventional power supply plug.

FIG. 2 is an exploded sectional view of the present invention.

FIG. 3 is an exploded sectional view of another side of the present invention.

FIG. 4 is a sectional view of the assembled present invention.

FIG. 5 is a sectional view of the assembled present invention from the opposite side.

FIG. 6 is a sectional view showing the folded plug of the present invention.

FIG. 7 is a sectional view showing the folded plug from the opposite side of the present invention.

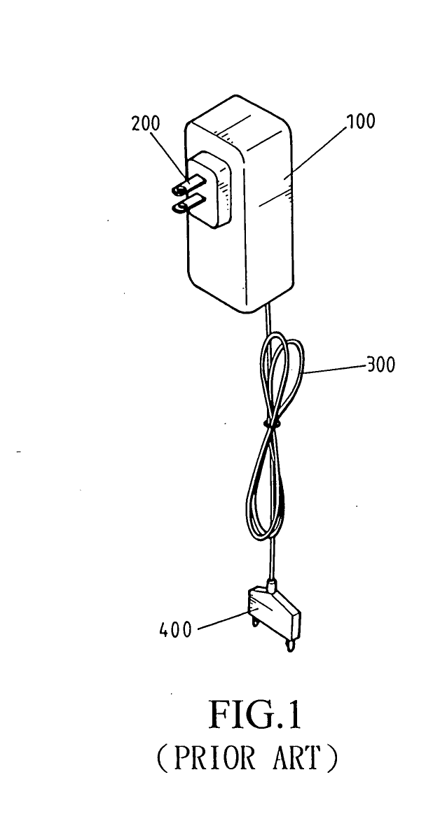

### DETAILED DESCRIPTION OF THE PREFERRED EMBODIMENTS

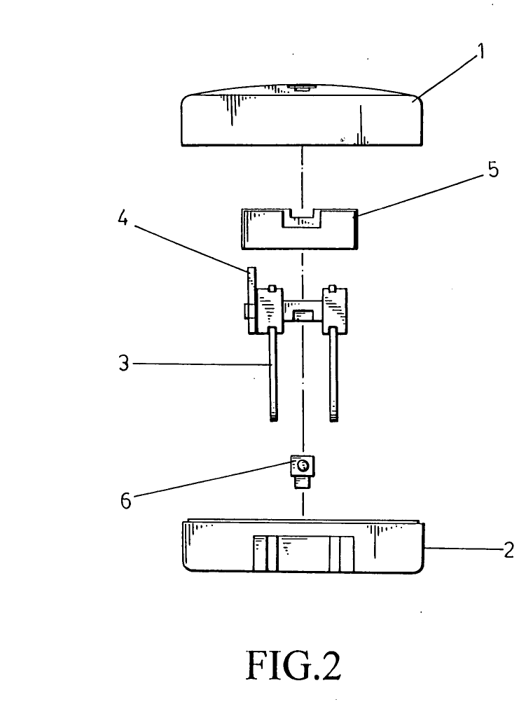

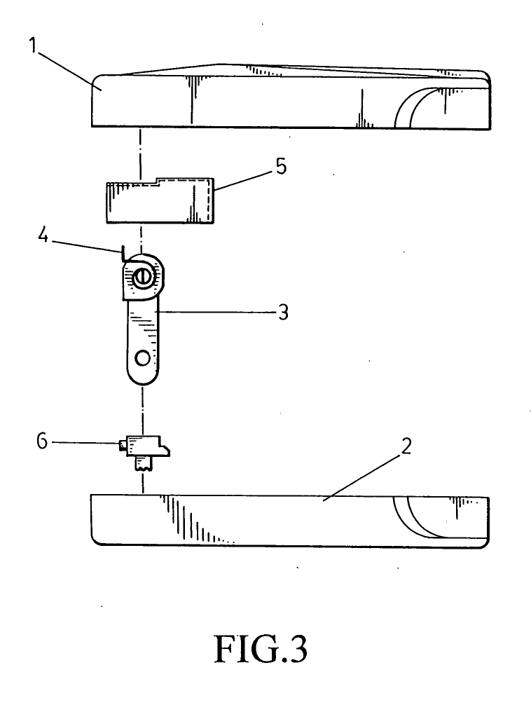

Referring to FIGS. 2, 3, 4 and 5, the present invention is comprised of an upper cover (1), a lower cover (2), a plug (3), a spring (4), a plug-securing case (5), and a button switch (6). Said plug (3), spring (4), plug-securing case (5) and button switch (6) are contained within the upper (1) and lower covers (2). Said spring (4) is connected with said plug (3) which is enclosed in said plug-securing case (5). The button switch (6) controls the position of engagement of spring (4) with plug (3).

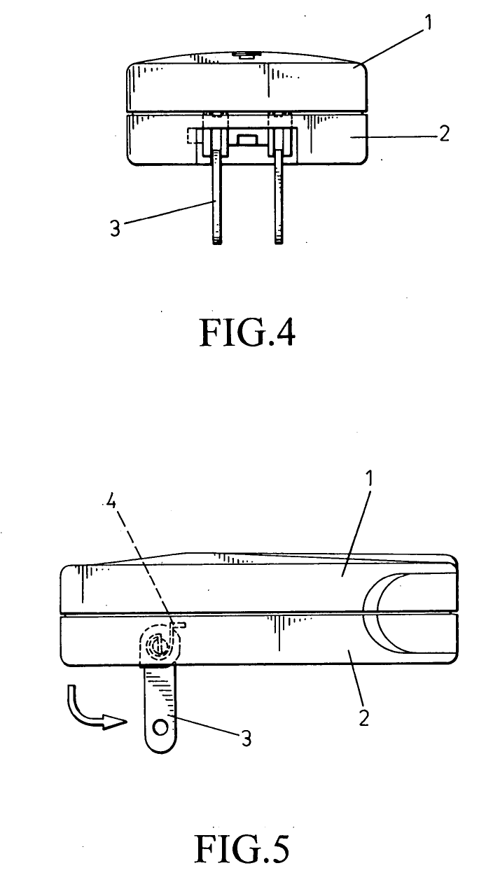

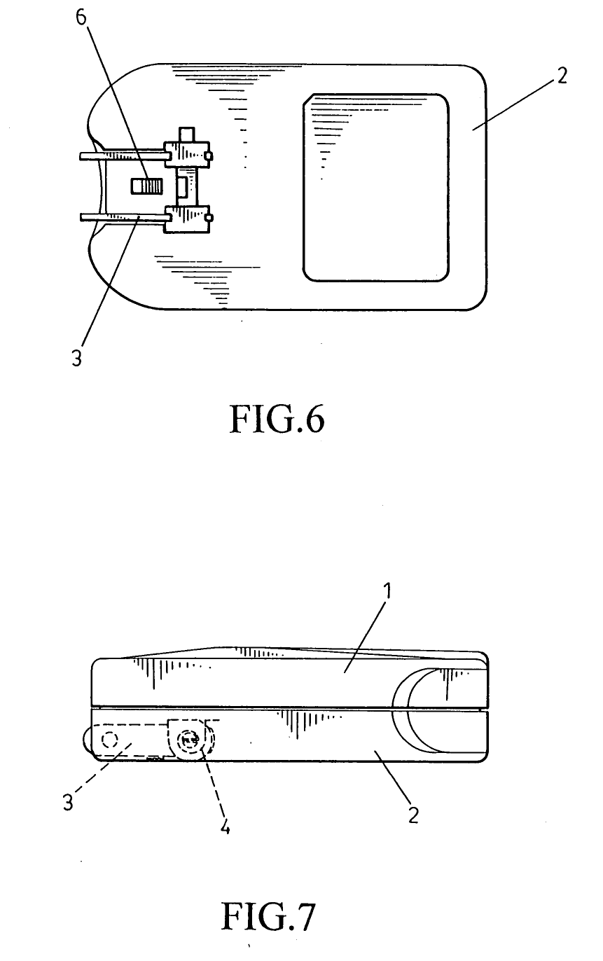

As shown in FIGS. 6 and 7, said plug (3) is folded and concealed in the lower cover (2) when not in use. To use plug (3), one simply presses the button switch (6), and the spring (4) then releases the plug (3). Referring to FIGS. 4 and 5, the plug (3) is actuated and can be inserted into an ordinary outlet.

As mentioned above, the present invention allows the plug to be folded into the housing and prevents the plug from bending caused by extrinsic forces. To use the plug, simply press the button switch, and the plug flips out to a vertical position against the housing.

1. A foldable power supply plug comprising:
a housing having an upper cover and a lower cover coupled with each other;
a plug hinged to the lower cover, the plug having first and second ends;
a spring positioned in the lower cover and connected with the first end of the plug;
a case placed within the housing and the case substantially encloses the plug;
a button switch placed within the housing and in communication with the spring;
when unused, the plug is folded inside the lover cover such that the second end of the plug is partially exposed beyond the lower cover and the spring is compressed; and
upon pressing the button switch, the spring is released and the plug is unfolded and actuated to conduct electricity therethrough.
